(19) United States
(12) Patent Application Publication
(10) Pub. No.: US 2007/0124554 A1
(43) Pub. Date: May 31, 2007

(54) Global memory for a rapidio network

(75) Inventors: Mark E. Allen, Clearwater, FL (US); Clifford E. Kimmery, Clearwater, FL (US); James D. Parker, Tarpon Springs, FL (US); Daniel R. Tabor, Belleair Beach, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/261,087

(22) Filed: Oct. 28, 2005

(51) Int. Cl. G06F 12/00

(52) U.S. Cl. 711/163

(57) ABSTRACT

Systems and methods for global memory for a RapidIO network are provided. In one embodiment, a method for accessing global data on a RapidIO network comprises obtaining ownership of a global memory unit (GMU) and receiving a data write packet at a GMU endpoint on a RapidIO network. The data write packet includes a source network identifier and a dataset. The method further comprises verifying whether the source network identifier matches a lock owner network identifier stored in a first register, and verifying one or both of whether one or both of a processor endpoint and a controller endpoint are permitted to alter the lock owner network identifier, and whether the source network identifier identifies a processor endpoint authorized to write data on the GMU based on a set of authorized source network identifiers stored in a second register. The method further comprises storing the dataset on the GMU.

### TECHNICAL FIELD

The present invention generally relates to networks and more specifically to memory storage devices.

### BACKGROUND

Embedded systems often contain multiple processors. RapidIO provides an open standard for interconnecting embedded processors, allowing them to communicate and share data. Often, multiple processors in an embedded system are required to access and update specific sets of data. One means to make these shared datasets available to each embedded processor is for each processor to possess its own local copy of the shared dataset and transmit updates made to the shared dataset to the other embedded processors. The other embedded processors would then update their own local copy of the shared dataset. Because embedded systems typically have limited processing, memory storage and internal communications bandwidth resources, two issues arise using such means. First, there is need for each processor to maintain its own complete copy of the dataset. Second, propagating dataset updates among processors produces internal communications bus chatter. Both of these issues result in the consumption of scarce resources within the embedded system.

For the reasons stated above and for other reasons stated below which will become apparent to those skilled in the art upon reading and understanding the specification, there is a need in the art for improved sharing of data for multiple embedded processes in a RapidIO network.

### SUMMARY

The Embodiments of the present invention provide methods and systems for global memory for a RapidIO network and will be understood by reading and studying the following specification.

In one embodiment, a RapidIO network is provided. The network comprises at least one RapidIO switch; a plurality of processor endpoints coupled to communicate through the at least one RapidIO switch; and at least one global memory unit endpoint having a memory device and a RapidIO interface coupled to the at least one RapidIO switch, wherein the at least one global memory unit endpoint is adapted to communicate with the plurality of processor endpoints through the at least one RapidIO switch, and further adapted to one or both of store data in the memory device and retrieve data from the memory device based on one or more packets received from the plurality of processor endpoints. The network further comprises a lock mechanism that controls write access to the global memory unit, the lock mechanism including: a first register adapted to store a lock owner network identifier identifying a current owner of the global memory unit endpoint; and a second register adapted to store one of a set of authorized source network identifiers identifying one or more of the plurality of processor endpoints authorized to write to the memory device and at least one network identifier identifying at least one controller endpoint authorized to alter the lock owner network identifier.

In another embodiment, a global memory unit endpoint for a RapidIO network is provided. The endpoint comprises means for storing one or more datasets, and means for receiving one or more packets from a plurality of processor endpoints via a RapidIO network, the one or more packets each including one or both of a first source network identifier and a first dataset. The means for receiving is adapted to authenticate write access to the means for storing based on the first source network identifier matching a lock owner network identifier; and the means for receiving is further adapted to authenticate write access to the means for storing based on verifying one or both of: whether one or both of a processor endpoint and a controller endpoint are permitted to alter the lock owner network identifier, and whether the first source network identifier identifies a processor endpoint authorized to write data on the global memory unit based on a set of authorized source network identifiers. The means for receiving is adapted to write the first dataset to the means for storing one or more dataset when write access is authenticated.

In yet another embodiment, a method for storing global data on a RapidIO network is provided. The method comprises obtaining ownership of a global memory unit; receiving a data write packet at a global memory unit endpoint on a RapidIO network, wherein the data write packet includes a source network identifier and a dataset; and verifying whether the source network identifier matches a lock owner network identifier stored in a first register. The method further comprises verifying one or both of: whether one or both of a processor endpoint and a controller endpoint are permitted to alter the lock owner network identifier; and whether the source network identifier identifies a processor endpoint authorized to write data on the global memory unit based on a set of authorized source network identifiers stored in a second register. The method further comprises storing the dataset on the global memory unit.

### DRAWINGS

Embodiments of the present invention can be more easily understood and further advantages and uses thereof more readily apparent, when considered in view of the description of the preferred embodiments and the following figures in which:

FIG. 1A is a block diagram of a RapidIO network of one embodiment of the present invention;

FIG. 1B is a block diagram of a global memory unit of one embodiment of the present invention;

FIG. 1C is a block diagram illustrating a lock mechanism for a global memory unit of one embodiment of the present invention; and

FIG. 2 provides a flow chart illustrating a method for storing global data in a RapidIO network of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention address the needs for sharing global datasets among processors within a RapidIO network by establishing a global memory unit (GMU). In one embodiment, the GMU act as a stand alone endpoint entity within the RapidIO network. In other embodiments, the GMU is combined with other RapidIO endpoint functionality, such as, but not limited to, a CPU endpoint. The GMU comprises a RapidIO endpoint having a programmable network identifier that connects a memory device to the RapidIO network.

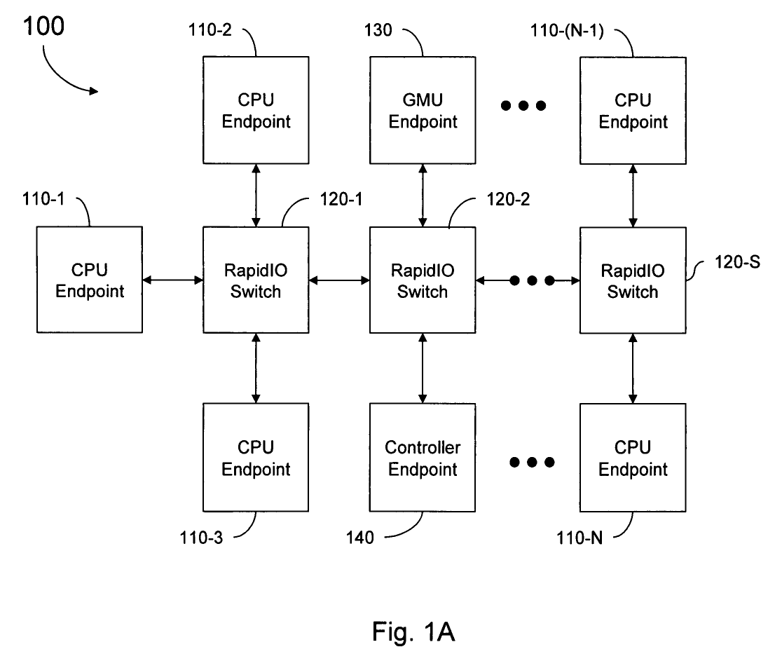

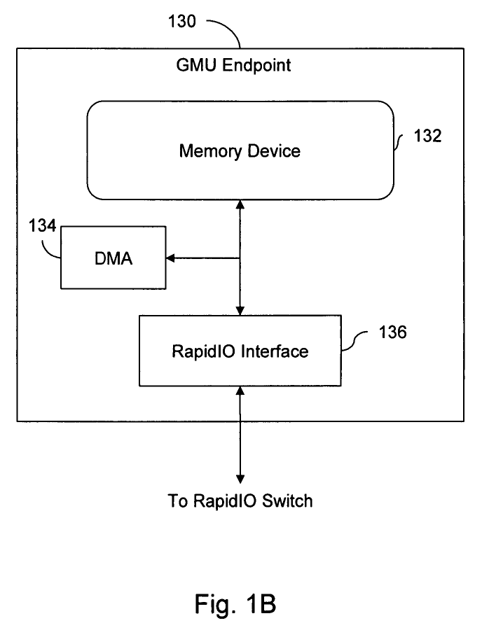

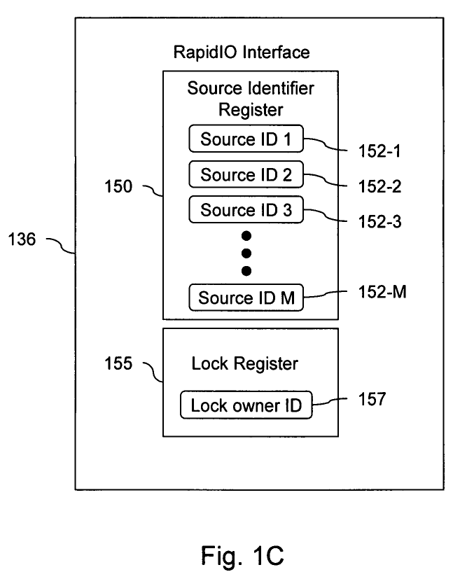

FIG. 1A is a block diagram of a RapidIO network 100 of one embodiment of the present invention. RapidIO Network 100 comprises a plurality of processor (CPU) endpoints, 110-1 to 110-N coupled to communicate through one or more RapidIO switches 120-1 to 120-S. RapidIO Network 100 may operate as one of either a parallel RapidIO network or a serial RapidIO network. Network 100 further comprises at least one GMU endpoint 130 which stores one or more global datasets used by one or more of CPU endpoints 110-1 to 110-N. GMU endpoint 130 is an active agent on Rapid 10 network 100, meaning GMU endpoint 130 is assigned a unique network identifier and processes RapidIO network packets as defined by the RapidIO standards implemented on network 100.

As illustrated in FIG. 1B, in one embodiment GMU endpoint 130 comprises a RapidIO interface 136 and a memory device 132. In one embodiment, memory device 132 includes one or more of a random access memory (RAM) device, an electrically erasable programmable read only memory (EEPROM), or similar device used to store digital data. In one embodiment, RapidIO interface 136 is coupled to send and receive packets from network 100, and to read data from, and write data to, memory device 132. In one embodiment, GMU endpoint 130 further comprises a direct memory access device (DMA) 134. In that case, RapidIO interface 136 is further configured to read data from, and write data to, memory device 132 via DMA 134.

Embodiments of the present invention further comprise a mutually-exclusive-access lock mechanism to prevent multiple CPU endpoints from attempting to access memory device 132 simultaneously. In a system where multiple elements may be authorized to write to GMU endpoint 130, such access must be ‘serialized’ so that one processing element does not interfere with the current activity of another. For example, due to the nature of EEPROM technology, writing to memory must be performed on a ‘page’ basis. Transferring the data to the current ‘page’ must not be interrupted and, once the page transfer is complete, the EEPROM device is unavailable until the ‘programming’ cycle is complete. The lock mechanism of embodiments of the present invention allows competing processing elements to coordinate access and prevent such interference.

As illustrated in FIG. 1C, to implement the lock mechanism of one embodiment of the present invention, RapidIO interface 136 comprises two registers, a source identifier register 150 and a lock register 155.

Each of CPU endpoints 110-1 to 110-N is uniquely identified on network 100 by a unique network identifier. In one embodiment, source identifier register 150 includes the network identifier (illustrated by “Source ID” 152-1 to 152-M) of each of the CPU endpoints 110-1 to 110-N which are authorized to write to memory device 132. (i.e., Source ID's 152-1 to 152-M comprise a set of authorized source network identifiers.) Further, in order to initialize and write to GMU endpoint 130, a CPU endpoint must own the lock for GMU endpoint 130. A CPU endpoint owns lock for GMU endpoint 130 only when a lock owner identifier (illustrated by “Lock owner ID” 157) within lock register 155 matches the network identifier of that CPU endpoint. Thus, for a CPU endpoint to write to memory device 132, both source identifier register 150 and lock register 155 must contain the CPU endpoint's network identifier.

In one embodiment, source identifier register 150 contains the network identifier of those of CPU endpoints 110-1 to 110-N that are allowed to access memory device 132. In one embodiment, any of CPU endpoints 110-1 to 110-N can send memory request packets to GMU endpoint 130 by sending the request to GMU endpoint 130's network identifier, and any of CPU endpoints 110-1 to 110-N can acquire the lock register 155 by writing their network identifier to lock register 155, thus becoming the lock owner. In that case, GMU endpoint 130 only accepts a memory request packet if a source identifier within the memory request packet matches the current contents of lock register 155 and is contained in source identifier register 150. In one embodiment, all other memory request packets are rejected with an error response.

In an alternate embodiment, only CPU endpoints 110-1 to 110-N having a network identifier listed in source identifier register 150 can acquire lock register 155. Attempts by any of CPU endpoints 110-1 to 110-N not listed in source identifier register 150 to write their network identifier to lock register 155 are rejected with an error response. As described above, GMU endpoint 130 only accepts a memory request packet if a source identifier within the memory request packet matches the current contents of source identifier register 150 and lock register 155. In one embodiment, all other memory request packets are rejected with an error response.

In one embodiment, when a CPU endpoint, such as CPU endpoint 110-1, needs to write to memory device 132, it checks lock register 155 to determine whether it owns GMU endpoint 130. In one embodiment, when lock register 155 contains the network identifier for CPU endpoint 110-1, then CPU endpoint 110-1 may proceed to write to memory device 132. In one embodiment, when lock register 155 contains the network identifier for another of CPU endpoints 110-2 to 110-N, then CPU endpoint 110-1 does not own GMU endpoint 130 and will not proceed to write to memory device 132. In one embodiment, when lock register 155 contains a “no owner” identifier code (e.g. an arbitrary predefined code such as lock register 155 containing all l's) then endpoint 110-1 knows that GMU endpoint 130 is not owned by anyone. In that case, in one embodiment CPU endpoint 110-1 writes its own network identifier into lock register 155 (thus claiming ownership of GMU endpoint 130) and then proceeds to write to memory device 132. In one embodiment, CPU endpoint 110-1 can request ownership of lock register 155 by writing its network identifier to lock register 155 at any time, but, lock register 155 will only be affected if it contains the “no owner” identifier code. CPU endpoint 110-1 can assume that it acquired ownership of GMU endpoint 130 and proceed to issue memory access requests. If the acquisition of GMU endpoint 130 was unsuccessful, GMU endpoint 130 will reject those requests since the packet source identifier does not match the current lock register 155. In one embodiment, CPU endpoint 110-1 relinquishes lock register 155 in the same way it is acquired: by writing its network identifier to lock register 155.

In one embodiment, lock register 155 implements a two-state state-machine. The two states are locked and unlocked. When the state machine is unlocked, lock register 155 contains the “no owner” code. When the state machine is locked, the lock register 155 contains the “network ID” of the owner. The state machine always transitions from the locked state to the unlocked state or from the unlocked state to the locked state. If unlocked, the state can be changed to locked by writing a legal network identifier to lock register 155. If locked, the state can be changed to unlocked by writing the network identifier of the current owner to lock register 155. Writing an illegal network identifier to lock register 155 has no effect. When the state is locked, writing a legal network identifier to lock register 155 that doesn't match the current owner has no effect. In one embodiment, a legal network identifier is defined as any network identifier contained in source identifier register 150. The special meaning of the “no owner” identifier code overrides its use as a legal network identifier.

In an alternate embodiment, network 100 further comprises a controller endpoint 140. In one embodiment, only controller endpoint 140 alters the contents of lock register 155. In that case, in one embodiment, when a CPU endpoint, such as CPU endpoint 110-1, needs to write to memory device 132, CPU endpoint 110-1 requests access from controller endpoint 140, which in turn grants ownership of GMU endpoint 130 to CPU endpoint 110-1 by writing CPU endpoint 110-I's network identifier to lock register 155. In one embodiment, when CPU endpoint 110-1 has completed writing, then controller endpoint 140 re-writes CPU endpoint 110-i's network identifier code back to lock register 155. In one embodiment, source identifier register 150 contains the network identifier of those endpoints in network 100 that are allowed to modify lock register 155. Thus, any RapidIO network agent on network 110 can send memory request packets to GMU endpoint 130, but only endpoints having their network identifier listed in the source identifier register 150 can modify lock register 155. All other attempts to modify lock register 155 are rejected with an error response. In one embodiment, source identifier register 150 includes the network identifier of controller endpoint 140, allowing controller endpoint 140 to grant CPU endpoint 110-1 access to GMU endpoint 130 by writing the network identifier of CPU endpoint 110-1 to lock register 155. In this case, GMU endpoint 130 only accepts memory request packets having a source network identifier that matches the current contents of the lock register 155. All other memory request packets are rejected with an error response.

In one embodiment, RapidIO interface 136 is configured to read data from, and write data to, memory device 132 based on RapidIO Logical I/O packets received from network 100. As would be appreciated by one skilled in the art upon reading this specification, several alternative RapidIO logical protocols are applicable for describing the interaction behavior of endpoints within network 100, embodiments of which are included within the scope of the present invention. One such embodiment is described below.

In one embodiment, upon obtaining ownership of GMU endpoint 130 as described above, when a processor, such as CPU endpoint 110-1 needs to update data residing in GMU endpoint 130, CPU endpoint 110-1 transmits an GMU data write packet onto RapidIO network 100. In one embodiment, the GMU data write packet comprises a logical I/O protocol packet compliant with version 1.3, or later, of the RapidIO Input/Output Logical and Common Transport Layer Specification. As would be appreciated by one skilled in the art, the RapidIO I/O logical protocol implements a memory mapped communications mechanism. In one embodiment, the GMU data write packet comprises the network identifier of its source endpoint (i.e., CPU endpoint 110-1) in order to verify the packet is from a CPU endpoint 110-1 authorized to write to memory device 132. In one embodiment, the GMU data write packet further comprises the RapidIO network identifier associated with destination GMU endpoint 130 and payload data to be stored in memory device 132. In one embodiment, the GMU data write packet further comprises a storage location that identifies one or more memory addresses or a region within memory device 132 to store the data. In one embodiment, the storage location identifies a specific state variable (or other identifier such as a register) uniquely associated with the dataset. When GMU endpoint 130 receives the GMU data write packet, RapidIO interface 136 writes the payload data included in the GMU data write packet to memory device 132. In one embodiment RapidIO interface 136 then transmits an update acknowledgement via a RapidIO compliant packet back to CPU endpoint 110-1 via network 100 to indicate that the write was completed.

In one embodiment, when a processor, such as CPU endpoint 110-1 needs to read data residing in GMU endpoint 130, CPU endpoint 110-1 transmits a GMU data read packet requesting the information onto RapidIO network 100. In one embodiment, the GMU data read packet comprises a logical I/O protocol packet compliant with version 1.3, or later, of the RapidIO Input/Output Logical and Common Transport Layer Specification. In one embodiment, the GMU data read packet comprises a RapidIO network identifier associated with destination GMU endpoint 130 and a storage location that identifies where the requested data is stored within memory device 132. In one embodiment, the storage location specifies a specific range of memory addresses or other region of memory within memory device 132 that holds the requested data. In one embodiment, the storage location identifies a specific state variable or other identifier associated with a specific dataset. In one embodiment, the GMU data read packet further comprises the network identifier of source CPU endpoint 110-1 so that GMU endpoint knows where to send the dataset retrieved from memory device 132.

When GMU endpoint 130 receives the GMU data read packet, RapidIO interface 136 identifies the GMU data read packet as a request for the specific data and reads that data from memory device 132. In one embodiment, the storage location identifies a specific state variable (or other identifier such as a register) uniquely associated with the dataset. RapidIO interface 136 then formats the data into a RapidIO compliant packet and transmits the data back to CPU endpoint 110-1 via network 100.

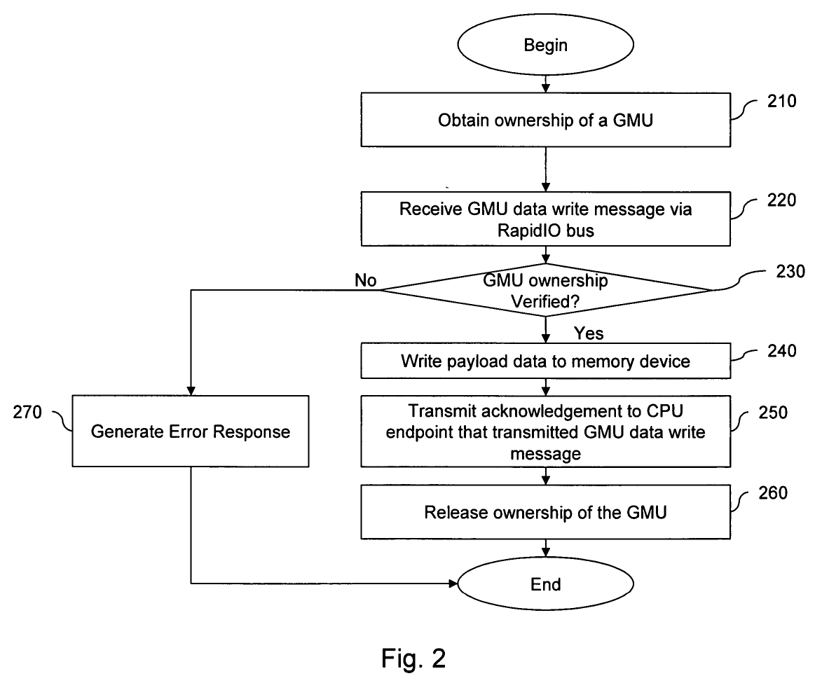

FIG. 2 provides a flow chart illustrating a method for storing global data in a RapidIO network of one embodiment of the present invention. The method begins at 210 with obtaining ownership of a GMU. In one embodiment, ownership of a GMU is obtained by a CPU endpoint when the CPU endpoint's network identifier is contained in a GMU lock register. In one embodiment, ownership of a GMU is obtained by a CPU endpoint only when the network identifier of the CPU endpoint is further included in a GMU source identifier register as described above. In an alternate embodiment, ownership of a GMU is obtained by a CPU endpoint when the network identifier of the CPU endpoint is written to the GMU lock register by a controller endpoint, where the network identifier of the controller endpoint is included in the GMU source identifier register.

The method proceeds to 220 where the GMU receives a GMU data write packet. In one embodiment, the GMU data write packet comprises both a network identifier of the source CPU endpoint that transmitted the data write packet, and the network identifier of a destination GMU intended to receive the data write packet. In one embodiment, when the RapidIO network comprises a plurality of GMUs, the destination network identifier identifies which of the GMUs is to receive the GMU data write packet. In one embodiment, the GMU data write packet further comprises payload data (i.e. data that the CPU endpoint wishes to store in the GMU) and a storage location indicating where within the GMU to store the payload data.

In one embodiment, the method proceeds to 230, with verifying GMU ownership. In one embodiment, GMU ownership is verified by confirming that the source network identifier of the GMU data write packet is contained in both the GMU source identifier register and the GMU lock register. In an alternate embodiment GMU ownership GMU ownership is verified by confirming that the source network identifier of the GMU data write packet is contained within the GMU lock register, where the GMU source identifier register contains the network identifier of one or more RapidIO endpoints permitted to alter the contents of the GMU lock register.

The method then continues to 240 with writing the payload data to a memory device within the GMU. In one embodiment, the GMU extracts the payload data from the data write packet and stores the data in memory as specified by the storage location. In one embodiment, the storage location identifies a region within the GMU in which to store the payload data. In one embodiment, the storage location identifies one or more memory addresses within the GMU in which to store the payload data. In one embodiment, the storage location identifies one or both of a state variable and a register associated with the payload data, and the GMU allocates memory and stores the data based on the storage location. In one embodiment, the method continues at 250 with transmitting and acknowledgement packet back to the CPU endpoint that transmitted GMU data write packet. Upon receipt of the acknowledgement, in one embodiment the CPU endpoint releases ownership of the GMU (260).

In one embodiment, when verifying GMU ownership at 230 determines that a GMU data write packet was received from a CPU endpoint that does not own the GMU, the method proceed from 230 to 270 with generating an error response to the CPU endpoint.

Once stored in the GMU endpoint, the data is then globally available for use by any processor on the RapidIO network. No special network traffic controller to coordinate GMU data read packets on the RapidIO network is required because packets between a CPU endpoint and a GMU endpoint are formatted and managed the same as any other RapidIO packet on the network. In one embodiment, access to the GMU and trafficking of read instructions and data is handled by a controller such as controller endpoint 140.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A RapidIO network, the network comprising:
at least one RapidIO switch;
a plurality of processor endpoints coupled to communicate through the at least one RapidIO switch; and
at least one global memory unit endpoint having a memory device and a RapidIO interface coupled to the at least one RapidIO switch, wherein the at least one global memory unit endpoint is adapted to communicate with the plurality of processor endpoints through the at least one RapidIO switch, and further adapted to one or both of store data in the memory device and retrieve data from the memory device based on one or more packets received from the plurality of processor endpoints; and
a lock mechanism that controls write access to the global memory unit, the lock mechanism including:
a first register adapted to store a lock owner network identifier identifying a current owner of the global memory unit endpoint; and
a second register adapted to store one of a set of authorized source network identifiers identifying one or more of the plurality of processor endpoints authorized to write to the memory device and at least one network identifier identifying at least one controller endpoint authorized to alter the lock owner network identifier.

2. The network of claim 1, wherein the memory device comprises one or more of a random access memory (RAM) device and an electrically erasable programmable read only memory (EEPROM) device.

3. The network of claim 1, the at least one global memory unit endpoint further comprising a direct memory access device coupled to the RapidIO interface and the memory device, wherein the direct memory access device is adapted to one or both of store data received from the RapidIO interface in the memory device and send data read from the memory device to the RapidIO interface.

4. The network of claim 1, wherein the one or more packets comprise one or more of a source network identifier, a destination network identifier, a data payload, and a storage location.

5. The network of claim 1, further comprising:
a controller endpoint coupled to the at least one RapidIO switch, the controller endpoint adapted to alter the lock owner network identifier stored in the first register based on one or more packets from one or more of the plurality of processor endpoints.

6. The network of claim 1, wherein when the at least one global memory unit endpoint receives a data write packet from a first processor endpoint of the plurality of processor endpoints having a dataset payload and a source network identifier identified in the first register and the second register, the at least one global memory unit is adapted to write the dataset payload to the memory device.

7. The network of claim 6, wherein the at least one global memory unit endpoint is further adapted to transmit an acknowledgement packet to the first processor endpoint.

8. The network of claim 1, wherein when the at least one global memory unit endpoint receives a data read packet from a first processor endpoint of the plurality of processor endpoints, the at least one global memory unit is adapted to read a dataset from the memory device and transmit the dataset as a RapidIO packet to the first processor endpoint.

9. The network of claim 8, wherein the data read packet comprises one or more of a destination network identifier and a storage location.

10. A global memory unit endpoint for a RapidIO network, the endpoint comprising:
means for storing one or more datasets;
means for receiving one or more packets from a plurality of processor endpoints via a RapidIO network, the one or more packets each including one or both of a first source network identifier and a first dataset;
wherein the means for receiving is adapted to authenticate write access to the means for storing based on the first source network identifier matching a lock owner network identifier; and
wherein the means for receiving is further adapted to authenticate write access to the means for storing based on verifying one or both of:
whether one or both of a processor endpoint and a controller endpoint are permitted to alter the lock owner network identifier; and
whether the first source network identifier identifies a processor endpoint authorized to write data on the global memory unit based on a set of authorized source network identifiers; and
wherein the means for receiving is adapted to write the first dataset to the means for storing one or more dataset when write access is authenticated.

11. The endpoint of claim 10, wherein the means for receiving is further adapted to read the one or more datasets from the means for storing one or more datasets; and
when the means for receiving receives a data read packet from a first processor endpoint requesting the first dataset, the means for reading is adapted to transmit a packet comprising the first dataset to the first processor endpoint.

12. The endpoint of claim 10, further comprising:
wherein the means for receiving is further adapted to one or both of transmit a packet comprising an acknowledgement to a processor endpoint based on the first source network identifier and transmit a packet comprising an error response to a processor endpoint based on the first source network identifier.

13. The network of claim 10, wherein the means for storing one or more datasets comprises one or more of a random access memory (RAM) means and an electrically erasable programmable read only memory (EEPROM) means.

14. A method for storing global data on a RapidIO network, the method comprising:
obtaining ownership of a global memory unit;
receiving a data write packet at a global memory unit endpoint on a RapidIO network, wherein the data write packet includes a source network identifier and a dataset;
verifying whether the source network identifier matches a lock owner network identifier stored in a first register;
verifying one or both of:
whether one or both of a processor endpoint and a controller endpoint are permitted to alter the lock owner network identifier; and
whether the source network identifier identifies a processor endpoint authorized to write data on the global memory unit based on a set of authorized source network identifiers stored in a second register; and
storing the dataset on the global memory unit.

15. The method of claim 14, wherein verifying whether one or both of a processor endpoint and a controller endpoint are permitted to alter the lock owner network identifier further comprises:
determining whether a network identifier of one or both of the processor endpoint and the controller endpoint is identified in the second register.

16. The method of claim 14 further comprising:
receiving a data read packet at the global memory unit endpoint on the RapidIO network;
reading the dataset from the memory device based on the data read packet; and
transmitting the dataset to a first processor endpoint of a plurality of processor endpoints, wherein the first processor endpoint transmitted the data read packet.

17. The method of claim 16, wherein reading the dataset from the memory device based on the data read command further comprises reading the dataset from a storage location specified by the data read packet.

18. The method of claim 17, wherein the storage location specifies at least one of a memory address, a register, a state variable.

19. The method of claim 14, wherein storing the dataset on the global memory unit further comprises:
extracting a dataset payload from the data write packet; and
writing the dataset payload to a memory device based on the data write packet.

20. The method of claim 19 further comprising:
transmitting an acknowledgement to a first processor endpoint of a plurality of processor endpoints, wherein the first processor endpoint transmitted the data write packet.

21. The method of claim 19, wherein writing the dataset payload to the memory device based on the data write command further comprises writing the dataset payload to a storage location specified by the data write packet.

22. The method of claim 21, wherein the storage location specifies at least one of a memory address, a register, a state variable.
